(19) United States
(12) Patent Application Publication
(10) Pub. No.: US 2024/0360373 A1
(43) Pub. Date: Oct. 31, 2024

(54) METHOD AND SYSTEM FOR PRODUCING REFINED HYDROCARBONS AND SOLID COKE FROM WASTE PLASTICS

(71) Applicants: SK INNOVATION CO., LTD., Seoul (KR); SK GEO CENTRIC CO., LTD., Seoul (KR)

(72) Inventors: Sang Hwan JO, Daejeon (KR); Yong Woon KIM, Daejeon (KR); Soo Kil KANG, Daejeon (KR); Min Gyoo PARK, Daejeon (KR); Ik Hwan NA, Daejeon (KR); Min Woo SHIN, Daejeon (KR); Seung Han YU, Daejeon (KR); Jae Hwan LEE, Daejeon (KR); Jin Seong JANG, Daejeon (KR); Yong Seong JEONG, Daejeon (KR)

(21) Appl. No.: 18/637,453

(22) Filed: Apr. 17, 2024

(30) Foreign Application Priority Data
Apr. 19, 2023 (KR) 10-2023-0051637
Mar. 12, 2024 (KR) 10-2024-0034229

(51) Int. Cl. C10G 69/02; B01D 17/04; B01D 17/06; B01D 39/06; B01D 46/30; B01J 6/00; C10B 53/07; C10B 55/00

(52) U.S. Cl. CPC C10G 69/02; B01D 17/047; B01D 17/06; B01D 39/06; B01D 46/30; B01J 6/008; C10B 53/07; C10B 55/00; B01D 2273/20; C10G 2300/1003

(57) ABSTRACT

A method and associated system for producing refined hydrocarbons from waste plastics. The method and associated system provide for pretreating waste plastics; a producing a pyrolysis gas by introducing the waste plastics pretreated in the pretreatment process into a pyrolysis reactor; producing in a lightening process a pyrolysis oil by introducing the pyrolysis gas into a hot filter; dehydrating a first mixed solution, obtained by mixing the produced pyrolysis oil with washing water and a demulsifier, by applying a voltage to the first mixed solution; hydrotreating a second mixed solution obtained by mixing the dehydrated first mixed solution with a sulfur source to produce a refined pyrolysis oil from which impurities are removed; and coking the refined pyrolysis oil, wherein a liquid condensed in the hot filter is re-introduced into the pyrolysis reactor.

### CROSS-REFERENCE TO RELATED APPLICATIONS

This application claims priority under 35 U.S.C. § 119 to Korean Patent Application Nos. 10-2023-0051637, filed on Apr. 19, 2023 and 10-2024-0034229, filed on Mar. 12, 2024, in the Korean Intellectual Property Office, the disclosure of which is incorporated herein by reference in its entirety.

### TECHNICAL FIELD

The following disclosure relates to a method and system for producing refined hydrocarbons and solid coke from waste plastics.

### BACKGROUND

Since pyrolysis oil (such as waste plastic pyrolysis oil) produced by a cracking or pyrolysis reaction of waste materials contains a large amount of impurities caused by the waste materials, there is a risk of emission of air pollutants such as SOₓ and NOₓ when the pyrolysis oil is used as a fuel. In particular, during combustion, chlorine component is often converted into hydrogen chloride, which has a risk of causing device corrosion during a high-temperature treatment process, and is discharged. In addition, waste plastic pyrolysis oil may be blended in a limit amount with a high-value-added fuel such as gasoline or diesel oil because it has a higher content of impurities such as chlorine, nitrogen, and metals than oil produced from crude oil by a general method, and therefore, waste plastic pyrolysis oil needs to go through a refining process to be used in large quantities.

In the past, impurities such as chlorine, nitrogen, and metals were removed through post-treatment processes such as a hydrodesulfurization (hydrotreating) process and a hydrogen chloride treatment process using an oil refining technique. However, since pyrolysis oil such as waste plastic pyrolysis oil has a high content of chlorine, problems such as equipment corrosion, abnormal reactions, and deterioration of product properties caused by an excessive amount of hydrogen chloride produced in the hydrodesulfurization process have been reported, and it is difficult to introduce non-pretreated pyrolysis oil into the hydrodesulfurization process.

In addition, when oil is allowed to react with hydrogen in the presence of a hydrotreating catalyst, a chlorine compound such as hydrogen chloride produced together with refined oil, and a nitrogen compound react with each other to form an ammonium salt (NH₄Cl), and the ammonium salt causes various process problems. Specifically, the ammonium salt formed inside the reactor by the reaction of oil and hydrogen not only causes corrosion of the reactor to reduce durability, but also causes various process problems such as occurrence of a differential pressure and a reduction in process efficiency therefrom.

### SUMMARY

In one general aspect of the present disclosure, a method for producing refined hydrocarbons from waste plastics includes: a pretreating waste plastics; producing a pyrolysis gas by introducing the waste plastics pretreated in the pretreatment process into a pyrolysis reactor; producing in a lightening process a pyrolysis oil by introducing the pyrolysis gas into a hot filter; dehydrating a first mixed solution, obtained by mixing the produced pyrolysis oil with washing water and a demulsifier, by applying a voltage to the first mixed solution; hydrotreating a second mixed solution obtained by mixing the dehydrated first mixed solution with a sulfur source to produce a refined pyrolysis oil from which impurities are removed; and coking the refined pyrolysis oil, wherein a liquid condensed in the hot filter is re-introduced into the pyrolysis reactor.

The hot filter may be filled with beads.

The beads may include at least one or more selected from the group consisting of silica sand (SiO₂) and aluminum oxide (Al₂O₃).

A temperature gradient may be formed in the hot filter.

The temperature gradient may be formed by providing at least two heaters outside the hot filter.

The pyrolysis reactor may include at least two batch reactors.

The pyrolysis process may be performed by switching operations between the at least two batch reactors.

The refined pyrolysis oil may be mixed with petroleum hydrocarbons and coked as mixed oil.

The refined pyrolysis oil may be included in an amount of 90 wt % or less with respect to the total weight of the mixed oil.

The waste plastics may include at least one or more selected from the group consisting of polyethylene (PE), polypropylene (PP), polyethylene terephthalate (PET), polyvinyl chloride (PVC), and polystyrene (PS).

In the dehydration process, the pyrolysis oil may be mixed in a greater volume than the washing water.

In the dehydration process, the pyrolysis oil and the washing water may be mixed in the first mixed solution at a volume ratio ranging from 1:0.001 to 0.5.

In the dehydration process, the pyrolysis oil and the demulsifier may be mixed in the first mixed solution at a volume ratio ranging from 1:0.000001 to 0.001.

The demulsifier may be one or a mixture of two or more selected from the group consisting of polyethylene glycol, tert-butanol, acetone, alkylnaphthalene sulfonate, alkylbenzene sulfonate, a nonionic alkoxylated alkyl phenol resin, polyalkylene oxide, and polyoxyethylene sorbitan ester.

The method for producing refined hydrocarbons from waste plastics may further include, after the lightening process, distilling the pyrolysis oil.

Hydrocarbons derived from the pyrolysis oil separated in the distillation process and petroleum hydrocarbons may be mixed and coked as a mixed oil.

In another general aspect of the present disclosure, a system for producing refined hydrocarbons from waste plastics includes: a pretreatment device for pretreating waste plastics; a pyrolysis reactor for producing a pyrolysis gas by introducing the waste plastics pretreated in the pretreatment device; a hot filter for producing a pyrolysis oil by introducing the pyrolysis gas; a connection pipe connecting the hot filter and the pyrolysis reactor so that a liquid condensed in the hot filter is re-introducible into the pyrolysis reactor; a dehydration device for dehydrating a first mixed solution, obtained by mixing the produced pyrolysis oil with washing water and a demulsifier, by applying a voltage to the first mixed solution; a hydrotreating device for hydrotreating a second mixed solution obtained by mixing the dehydrated first mixed solution with a sulfur source to produce a refined pyrolysis oil from which impurities are removed; and a coking device for coking the refined pyrolysis oil.

The hot filter may be filled with beads.

The beads may include at least one or more selected from the group consisting of silica sand (SiO₂) and aluminum oxide (Al₂O₃).

The system may further include at least two heaters provided outside the hot filter.

Other features and aspects will be apparent from the following detailed description, the drawings, and the claims.

### BRIEF DESCRIPTION OF THE DRAWINGS

FIG. 1 is a flowchart showing a method for producing refined hydrocarbons and solid coke from waste plastics according to one embodiment of the present disclosure.

FIG. 2 is a process diagram for producing waste plastic pyrolysis oil according to another embodiment of the present disclosure.

FIG. 3 is a view of a hot filter according to still another embodiment of the present disclosure.

FIG. 4 is a process diagram of a dehydration process, a hydrotreating process, and a coking process according to another embodiment of the present disclosure.

### DETAILED DESCRIPTION OF EMBODIMENTS

The advantages and features of the present disclosure and methods for accomplishing them will become apparent from the embodiments described below in detail. However, the present disclosure is not limited to the embodiments disclosed below, but rather may be implemented in various different forms. The disclosed embodiments below are provided in order to allow those skilled in the art to make and use the present invention.

Unless defined otherwise, all terms (including technical and scientific terms) used in the present specification have the same meanings as commonly understood by those skilled in the art to which the present disclosure pertains.

Unless the context clearly indicates otherwise, the singular forms of the terms used in the present specification may be interpreted as including the plural forms.

A numerical ranged used in the present specification includes upper and lower limits and all values within these limits, increments logically derived from a form and span of the defined range, all double limited values, and all possible combinations of the upper and lower limits in the numerical range defined in different forms. Unless otherwise specifically defined in the present specification of the present disclosure, values (out of the numerical range that may occur due to experimental errors or rounded values) also fall within the defined numerical range.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or processes, all of which are not further recited herein.

Unless otherwise defined, a unit of “%” used in the present specification refers to “wt %”.

In the present specification, the description “A to B” means “A or more and B or less”, and ranges from A to B, unless defined otherwise.

In the present specification, as used herein, the term “pyrolysis oil yield” refers to a weight ratio of the pyrolysis oil produced to the total weight of the oil, an aqueous by-product, a pyrolysis residue (char), and a by-product gas, that is a weight ratio of the pyrolysis oil produced to the total weight of all the products produced in the pyrolysis process.

The term “vertical electrode” used in the present specification may refer to an electrode erected in a vertical direction with respect to the ground, and the term “horizontal electrode” may refer to an electrode laid horizontally with respect to the ground.

Hereinafter, a method and a system for producing refined hydrocarbons from the waste plastics of the present disclosure will be described in detail. However, this is only illustrative, and the present disclosure is not limited to the specific embodiments illustratively described by the present disclosure.

In order to remove Cl oil using conventional oil refining process, there is a need for a Cl reduction treatment technique for reducing a content of Cl in the pyrolysis oil to a level that it may be introduced into the oil refining process. When the process is operated for a long period of time, impurity particles in the waste plastic pyrolysis oil adhere to the inside of the reactor, causing various process problems.

Therefore, there is a need for a technique that may prevent or minimize formation of an ammonium salt (NH₄Cl) and may prevent impurity particles from adhering to the inside of a reactor in a refining process of waste plastic pyrolysis oil containing impurities including chlorine and nitrogen.

In addition, in order to secure economic feasibility in addition to impurity removal, it is desirable for the waste plastic pyrolysis oil to be a high-value product. Furthermore, there is a need to develop a technique for obtaining high quality refined hydrocarbons from the waste plastic pyrolysis oil.

The present invention arises in the context of these needs.

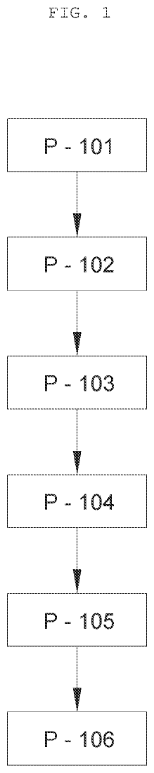

Referring to FIG. 1, the present disclosure in one embodiment provides a method for producing refined hydrocarbons from waste plastics, the method including: a pretreatment process (P-101) of pretreating waste plastics; a pyrolysis process (P-102) of producing a pyrolysis gas by introducing the waste plastics pretreated in the pretreatment process into a pyrolysis reactor 14; a lightening process (P-103) of producing a pyrolysis oil by introducing the pyrolysis gas into a hot filter 15; a dehydration process (P-104) of dehydrating a first mixed solution, obtained by mixing the produced pyrolysis oil with washing water and a demulsifier, by applying a voltage to the first mixed solution; a hydrotreating process (P-105) of hydrotreating a second mixed solution obtained by mixing the dehydrated first mixed solution with a sulfur source to produce a refined pyrolysis oil from which impurities are removed; and a coking process (P-106) of coking the refined pyrolysis oil, wherein a liquid condensed in the hot filter is re-introduced into the pyrolysis reactor.

Therefore, in the method for producing refined hydrocarbons from waste plastics according to one embodiment of the present disclosure, a high-value-added pyrolysis oil having a high proportion of light hydrocarbons (as shown illustratively in the Examples below with a 59 wt % or greater of light hydrocarbons obtained) may be produced from waste plastics containing a large amount of impurities, and refined hydrocarbons having a high proportion of light hydrocarbons and solid coke may be obtained therefrom. In addition, a yield of the obtained pyrolysis oil may be significantly improved relative to conventional processes used in the past.

In addition, in the method for producing refined hydrocarbons from waste plastics according to another embodiment of the present disclosure, a high-value-added pyrolysis oil with reduced impurities may be produced from waste plastics containing a large amount of impurities, and refined hydrocarbons with reduced impurities (e.g., removing 95 wt % to 99 wt % or more with respect to the impurity content in the waste plastics initially) may be obtained therefrom.

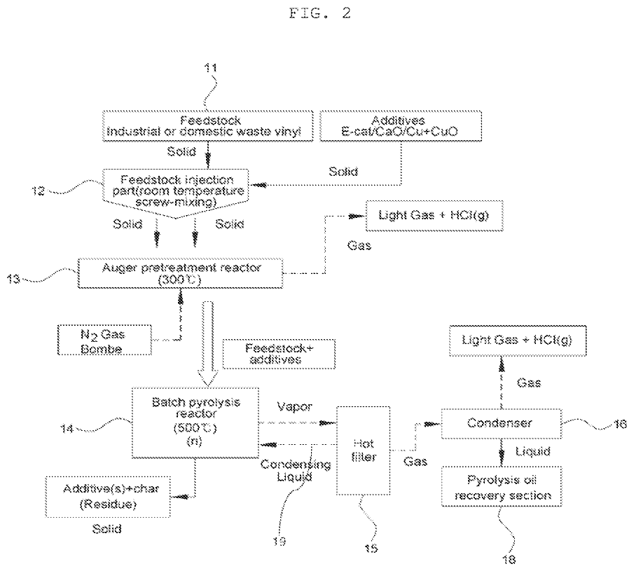

In the method for producing refined hydrocarbons from waste plastics according to another embodiment of the present disclosure and with reference to FIG. 2, a liquid condensed in hot filter 15 can be re-introduced into pyrolysis reactor 14, such that the cracking of heavy hydrocarbons in the pyrolysis oil may be improved. Therefore, pyrolysis oil having a higher proportion of light hydrocarbons (from the lightening process inside the hot filter 15) may be produced, and refined hydrocarbons having a high proportion of light hydrocarbons and solid coke may be obtained therefrom.

According to another embodiment of the present disclosure, the hot filter may be filled with beads. When the hot filter is filled with beads, an inert effect in which the beads do not chemically react with the waste plastic products and a heat transfer effect in the hot filter are maximized, which makes it possible to produce a pyrolysis oil having the above-noted high proportion of light hydrocarbons. In addition, the pyrolysis oil yield may be improved relative to conventional processes used in the past.

According to another embodiment of the present disclosure, the hot filter may be filled with the beads in an amount of 50 vol % or more, 60 vol % or more, 70 vol % or more, 80 vol % or more, 85 vol % or more, 90 vol % or more, 95 vol % or less, 93 vol % or less, 91 vol % or less, 90 vol % or less, 89 vol % or less, 87 vol % or less, 85 vol % or less, 80 vol % or less, or a value between the above numerical values with respect to an internal volume of the hot filter. Specifically, the hot filter may be filled with the beads in an amount of 70 to 95 vol %, 80 to 90 vol %, or 85 to 90 vol %, with respect to the internal volume of the hot filter, but the present disclosure is not limited thereto.

According to another embodiment of the present disclosure, a temperature gradient may be formed in the hot filter. When a temperature gradient is formed in the hot filter, the pyrolysis gas moving to the top of the hot filter and the liquid condensed to the bottom of the hot filter are efficiently circulated, which makes it possible to produce pyrolysis oil having the above-noted high proportion of light hydrocarbons. In addition, refined hydrocarbons having the above-noted high proportion of light hydrocarbons may be obtained therefrom. Further, the pyrolysis oil yield may be improved relative to conventionally observed yields from waste plastics.

A According to another embodiment of the present disclosure, as for the temperature gradient, a temperature at the bottom of the hot filter may be higher than a temperature at the top of the hot filter. According to another embodiment of the present disclosure, as for the temperature gradient, the temperature at the bottom of the hot filter may be higher than a temperature at the middle of the hot filter, and the temperature at the middle of the hot filter may be higher than the temperature at the top of the hot filter. Accordingly, circulation efficiency and heat transfer efficiency in the hot filter may be improved.

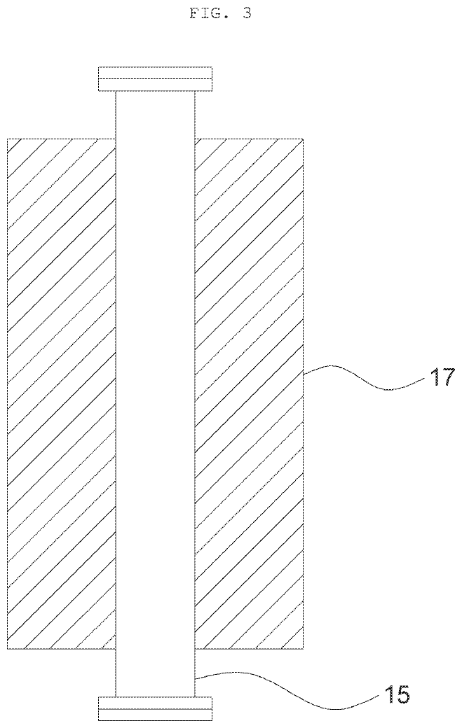

Referring to FIG. 3, according to another embodiment of the present disclosure, the temperature gradient may be formed by providing at least two heaters 17 outside the hot filter 15. According to another embodiment of the present disclosure, the temperature gradient may be formed by providing at least three heaters outside the hot filter. When at least two heaters are provided outside the hot filter, a temperature gradient of the hot filter may be formed, and the temperatures at the top, middle, and bottom of the hot filter may be adjusted depending on operating conditions of the hot filter, such that a flexible process operation may be performed. For example, the temperature gradient of the hot filter may be formed by providing heaters at the top, middle, and bottom of the hot filter, respectively, and independently adjusting the temperatures of the top, middle, and bottom of the hot filter.

According to one embodiment of the present disclosure, the temperature at the bottom of the hot filter may be 400° C. or higher, 420° C. or higher, 440° C. or higher, 460° C. or higher, 480° C. or higher, 500° C. or higher, 550° C. or higher, 600° C. or higher, 700° C. or lower, 600° C. or lower, 550° C. or lower, 530° C. or lower, 510° C. or lower, or a value between the above numerical values.

According to another embodiment of the present disclosure, the temperature at the top of the hot filter may be 400° C. or higher, 420° C. or higher, 440° C. or higher, 460° C. or higher, 480° C. or higher, 500° C. or higher, 600° C. or lower, 550° C. or lower, 500° C. or lower, 480° C. or lower, 460° C. or lower, 440° C. or lower, 420° C. or lower, or 400° C. or lower.

According to another embodiment of the present disclosure, the temperature at the middle of the hot filter may be 300° C. or higher and 600° C. or lower, 400° C. or higher and 600° C. or lower, 400° C. or higher and 500° C. or lower, 420° C. or higher and 480° C. or lower, or 440° C. or higher and 460° C. or lower.

According to another embodiment of the present disclosure, in the pretreatment process, a process a) of reacting waste plastics with a neutralizing agent; and a process b) of reacting a product in the process a) with a copper compound may be performed. Accordingly, in the pretreatment process, a waste plastic raw material may be treated to reduce a content of Cl to a level that may be introduced into an oil refining process.

According to one embodiment of the present disclosure, in the process b), an additive or a neutralizing agent such as a metal oxide or zeolite (that is a neutralizing agent other than a copper compound) may be used. The metal oxide may be in the form of a divalent metal oxide, but the present disclosure is not limited thereto.

The waste plastics may include at least one or more selected from the group consisting of polyethylene (PE), polypropylene (PP), polyethylene terephthalate (PET), polyvinyl chloride (PVC), and polystyrene (PS). The waste plastics may include organic chlorine (organic Cl), inorganic chlorine (inorganic Cl), and/or aromatic chlorine (aromatic Cl), and a content of chlorine in the waste plastics may be 10 ppm or more, 50 ppm or more, 100 ppm or more, or 100 to 1,000 ppm, but the present disclosure is not limited thereto. Pyrolysis oil (produced through a cracking or pyrolysis reaction of waste plastics, such as waste plastic pyrolysis oil) contains a large amount of impurities caused by the impurity content in the initial waste plastics. In one particular embodiment of the present disclosure, pyrolysis oil is pretreated to remove a chlorine component such as organic/inorganic chlorine. Waste plastics may be divided into domestic waste plastic and industrial waste plastic. The domestic waste plastic is a plastic in which PVC, PS, PET, PBT, and the like in addition to PE and PP are mixed, and may refer to a mixed waste plastic containing 3 wt % or more of PVC together with PE and PP. Since chlorine derived from PVC has a high ratio of organic Cl and inorganic Cl, Cl in domestic waste plastic may be removed with high efficiency even with an inexpensive neutralizing agent(s) (Ca-based, Zn-based, or Al-based) or the like. PE/PP accounts for most industrial waste plastic, but a content of organic Cl originating from an adhesive or a dye component is high, and in particular, a ratio of Cl (aromatic chlorine) contained in an aromatic ring is high, which makes it difficult to remove Cl with the inexpensive neutralizing agent(s) described above.

In one embodiment of the present disclosure, chlorine is removed in an amount of 95 wt % or more, 97 wt % or more, 98 wt % or more, or 99 wt % or more with respect to the total weight of chlorine contained in waste plastics. To this end, it is useful to remove chlorine contained in the aromatic ring.

According to one embodiment of the present disclosure, process a) is a process of reacting waste plastics with a neutralizing agent, and a large amount of hydrogen chloride generated during melting and thermal decomposition of PVC and the like may be removed in the form of a neutralizing salt.

The neutralizing agent may be oxide, hydroxide, and carbonate of a metal, or a combination thereof, and the metal may be for example calcium, aluminum, magnesium, zinc, copper, iron, or a combination thereof. Specifically, the neutralizing agent may be copper oxide, aluminum oxide, calcium oxide, magnesium oxide, zinc oxide, or iron oxide. The neutralizing agent may contain a zeolite component. Specifically, the neutralizing agent may contain a waste fluid catalytic cracking (FCC) catalyst (E-cat) containing a zeolite component, and may further contain a waste FCC catalyst in the metal oxide. Specifically, the neutralizing agent may be calcium oxide, a waste FCC catalyst, copper metal, or copper oxide, or may be calcium oxide.

In one embodiment according to the present disclosure, the neutralizing agent may be added during the pyrolysis process.

The neutralizing agent may be mixed in an amount ranging from 0.5 to 20 wt %, 1 to 10 wt %, or 1 to 5 wt %, with respect to the total weight of the waste plastics. In addition, the neutralizing agent may be mixed at a molar ratio (N_{M}/N_{Cl}) of a metal element (M) of the neutralizing agent to a total chlorine element (Cl) in the waste plastics ranging from 1 to 25, specifically, 0.7 to 15, and more specifically, 0.5 to 5.

Meanwhile, the number of moles of total chlorine elements (Cl) in the waste plastics may refer to a total number of moles of chlorine elements in a waste plastic solid raw material before pretreatment and pyrolysis.

In the chlorine removal in the process a), a ratio (C₁/C) of the content C₁ of chlorine in the product in the process a) to 100 wt % (C) of the content of chlorine in the waste plastics may be 50% or less, 40% or less, or 20 to 30%. Chlorine remaining in waste plastics after the process a) may be effectively removed in the process b).

According to one embodiment of the present disclosure, process b) is a process of reacting the product obtained in the process a) with a copper compound, whereby organic chlorine and aromatic chlorine not removed in the process a) may be removed with a copper compound (catalyst). When a copper compound is used together with the neutralizing agent in the process a) or when a copper compound is used as a substitute for the neutralizing agent, the copper compound first reacts with chlorine and inorganic chlorine (hydrogen chloride) located at the end of the hydrocarbon chain among organic chlorines, which makes it difficult for the copper compound to come into contact with aromatic chlorine or the like, which is difficult to remove with a neutralizing agent. In addition, since the initial pyrolysis performed by raising the temperature inside the reactor for pretreatment or pyrolysis starts at a relatively low temperature (250 to 300° C.), and at this time, hydrogen chloride begins to be generated, it is useful to first remove chlorine with a neutralizing agent. Thereafter, when pyrolysis proceeds at higher temperatures a removal reaction of aromatic chlorine is activated. Therefore, it is effective to first remove organic Cl and inorganic Cl with hydrogen chloride generated during the melting and thermal decomposition of the waste plastic using a neutralizing agent, and then remove the aromatic chlorine with a copper compound.

The copper compound may include at least one or more selected from the group consisting of copper metal (Cu), copper oxide (CuO), copper hydroxide (Cu(OH)₂), and copper carbonate (CuCO₃), and specifically, copper metal (Cu) and/or copper oxide (CuO).

The copper compound may be mixed in an amount of 0.1 to 20 wt %, 0.5 to 10 wt %, or 1 to 5 wt %, with respect to the total weight of the product in the process a). In addition, the copper compound may be mixed at a molar ratio (N_{Cu}/N_{Cl}) of a copper element (Cu) of the copper compound to the total chlorine element (Cl) in the waste plastics of 1 to 10, specifically, 0.7 to 5, and more specifically, 0.5 to 3.

Meanwhile, a total number of moles of chlorine element (Cl) in the waste plastics may refer to a total number of moles of chlorine element in a waste plastic solid raw material before pretreatment and pyrolysis.

In the chlorine removal in the process b), a ratio (C₂/C) of the content C₂ of chlorine in the product obtained in the process b) to 100 wt % (C) of the content of chlorine in the waste plastics may be 10% or less, 5% or less, or 0.5 to 3%.

According to another embodiment of the present disclosure, the process a) may be performed at a temperature of 200 to 320° C., and the process b) may be performed at a temperature of 400 to 550° C. When the processes a) and b) are performed in the temperature ranges, respectively, chlorine in the waste plastics may be effectively removed.

According to one embodiment of the present disclosure, in the pyrolysis process, a process a) of reacting waste plastics with a neutralizing agent; and a process b) of reacting a product in the process a) with a copper compound may be performed.

In the present disclosure, the pretreatment process may further include a crushing process of crushing the waste plastics by introducing waste plastics into a screw reactor. The crushing of the waste plastics may be performed by applying a crushing process known in the art. For example, waste plastics may be introduced into a pretreatment reactor 13 and heated to about 300° C. to produce a hydrocarbon flow precursor in the form of pellets, but the present disclosure is not limited thereto. According to one embodiment of the present disclosure, the crushing process may be performed at room temperature.

As an example, in the crushing process, the waste plastics and the neutralizing agent may be mixed, and the mixture may be introduced into a pretreatment reactor. When the waste plastics and calcium oxide as the neutralizing agent are mixed and crushed at room temperature, a mechanochemical reaction occurs to generate hydrocarbons and CaOHCl, and therefore, an effect of stably maintaining the form of chlorine (generated from the waste plastic raw material and calcium oxide) as CaOHCl is obtained.

Subsequently, in the pretreatment process, the crushed waste plastics may be introduced into the pretreatment reactor and heated, and the solid waste plastic raw material may be physically and chemically treated to remove chlorine, thereby producing a hydrocarbon flow precursor (pyrolysis raw material). As used herein, the hydrocarbon flow precursor means a waste plastic melt, and as used herein, the waste plastic melt means that all or a part of crushed or uncrushed solid waste plastics is converted into a liquid waste plastic.

As an example, in the pretreatment process, each of the crushed or uncrushed waste plastics and the neutralizing agent may be introduced into the pretreatment reactor and heated. In addition, in the pretreatment process, the crushed or uncrushed waste plastics and the neutralizing agent may be introduced into the pretreatment reactor, and then a first pretreatment (heating) may be performed, and subsequently, a copper compound may be introduced into the pretreatment reactor, and then a second pretreatment (heating) may be performed.

The heating may be performed at a temperature of 200 to 320° C. and normal (atmospheric) pressure. Specifically, the heating may be performed at a temperature of 250 to 320° C. or 280 to 300° C., but the present disclosure is not limited thereto. In general, the pretreatment temperature of the waste plastics is at least 250° C., but hydrocarbons after the dechlorination may be pretreated even at a lower temperature of 200° C. to generate hydrogen or methane gas.

The pretreatment reactor may be an extruder, an autoclave reactor, a batch reactor, or the like, and may be, for example, an auger reactor, but the present disclosure is not limited thereto.

The pyrolysis process may be performed by introducing pyrolysis raw materials classified into three material phases: a gas phase, a liquid phase (oil+wax+water), and a solid phase into the pyrolysis reactor, and specifically, may be a process of introducing the non-pretreated or pretreated waste plastics into the pyrolysis reactor and performing heating.

As an example, the pyrolysis process may be performed by mixing pretreated waste plastics and a divalent metal compound, specifically a copper compound, introducing the mixture into a pyrolysis reactor, and heating the mixture. In addition, in the pyrolysis process, a first pyrolysis is performed by mixing waste plastics and a neutralizing agent, introducing the mixture into a pyrolysis reactor, and heating the mixture, and then a second pyrolysis is performed by introducing a divalent metal compound, specifically a copper compound, into the pyrolysis reactor and performing heating, and at least two times of pyrolysis may be performed continuously or discontinuously.

The heating may be performed at a temperature ranging from 320 to 900° C., specifically, 350 to 700° C., and more specifically, 400 to 550° C., in a non-oxidizing atmosphere. In addition, the heating may be performed at normal pressure. The non-oxidizing atmosphere is an atmosphere in which waste plastics do not oxidize (combust), and may be, for example, an atmosphere in which an oxygen concentration is adjusted to 1 vol % or less, or an atmosphere of an inert gas such as nitrogen, water vapor, carbon dioxide, or argon.

When the heating temperature is 400° C. or higher, fusion of chlorine-containing plastics may be prevented, and conversely, when the heating temperature is 550° C. or lower, chlorine in waste plastics may remain in a pyrolysis residue (char) in the form of XCl₂, where X is a divalent metal cation, specifically CaCl₂, CuCl₂, or the like.

The pyrolysis may be performed in an autoclave reactor, a batch reactor, a fluidized-bed reactor, a packed-bed reactor, the like, and specifically, any reactor capable of or controlling stirring and controlling a rise in temperature may be applied. According to one embodiment of the present disclosure, the pyrolysis may be performed in a batch reactor.

According to another embodiment of the present disclosure, the pyrolysis reactor may include at least two batch reactors.

According to another embodiment of the present disclosure, the pyrolysis process may be performed by switching operations between the at least two batch reactors. Specifically, if one batch reactor is undergoing maintenance, the other batch reactor can continue to operate by the switching operation. Accordingly, the pyrolysis process may secure process continuity even at a high temperature.

In the method for producing refined hydrocarbons from waste plastics according to another embodiment of the present disclosure, the pyrolysis process and/or the lightening process may further include at least one or more processes selected from the group consisting of a pyrolysis gas recovery process of recovering a pyrolysis gas phase and a pyrolysis liquid phase as gas and a separation process of separating a pyrolysis solid phase (solid content) into fine particles and coarse particles.

In the pyrolysis gas recovery process, pyrolysis gas containing low-boiling-point hydrocarbon compounds such as methane, ethane, and propane in the gas phase generated in the pyrolysis process or the lightening process is recovered. The pyrolysis gas may generally contain combustible materials such monoxide, and low-molecular-weight as hydrogen, carbon hydrocarbon compounds. Examples of the hydrocarbon compounds include methane, ethane, ethylene, propane, propene, butane, and butene. Such pyrolysis gas contains a combustible material and may be used as fuel.

In the separation process, the solid content in the solid phase generated in the pyrolysis process and/or the lightening process, for example, carbides, the neutralizing agent, and/or the copper compound may be separated into fine particles and coarse particles. Specifically, classification is performed using a sieve having a size smaller than an average particle diameter of the chlorine-containing plastics and larger than an average particle diameter of the neutralizing agent or the copper compound, such that the solid content generated by the pyrolysis reaction may be separated into fine particles and coarse particles. In the separation process, it is useful to separate the solid content into fine particles containing a relatively large amount of the chlorine-containing neutralizing agent and the copper compound, and coarse particles containing a relatively large amount of carbides. The fine particles and carbides may be retreated as necessary, reused in the pyrolysis process, used as fuel, or disposed of as waste, but the present disclosure is not limited thereto.

According to one embodiment of the present disclosure, the hot filter may be filled with at least one or more selected from the group consisting of beads and a neutralizing agent.

According to another embodiment of the present disclosure, the hot filter may be filled with beads. When the hot filter is filled with beads, an inert effect and a heat exchange effect in the hot filter are maximized, which makes it possible to produce pyrolysis oil having the above noted high proportion of light hydrocarbons.

According to one embodiment of the present disclosure, the beads may include at least one or more selected from the group consisting of silica sand (SiO₂) and aluminum oxide (Al₂O₃). Specifically, when the beads include silica sand (SiO₂), the inert effect and the heat exchange effect in the hot filter may be maximized, and a stable process operation may be performed without wear even during a long-term high-temperature operation.

According to another embodiment of the present disclosure, the beads may be glass beads, but the beads in the present disclosure are not limited thereto.

According to one embodiment of the present disclosure, a diameter of the bead may be 0.1 mm or more, 1 mm or more, 1.5 or more, 2 mm or more, 2.5 mm or more, 3 mm or more, 10 mm or less, 8 mm or less, 6 mm or less, 4 mm or less, 3.5 mm or less, 3 mm or less, 2.5 mm or less, 2 mm or less, or a value between the above numerical values, and specifically, may be 1 mm to 5 mm, 2 mm to 4 mm, or 2.5 mm to 3.5 mm, but the present disclosure is not limited thereto. In the lightening process of the present disclosure, the hot filter is filled with beads having the particle size described above, such that lightening of the pyrolysis oil may be achieved by adjusting a gas hourly space velocity (GHSV) of the pyrolysis gas (where GHSV is calculated by dividing a volumetric gas flow rate per hour by the volume of the catalyst), and process operation efficiency may be improved due to suppression of a differential pressure in the hot filter.

According to another embodiment of the present disclosure, in the lightening process, pyrolysis oil may be produced by introducing the pyrolysis gas into the hot filter filled with a neutralizing agent.

The lightening process may be performed in an oxygen-free atmosphere at a temperature of 400 to 550° C. and a pressure of normal pressure to 0.5 bar, and the oxygen-free atmosphere may be an inert gas atmosphere or a closed system atmosphere without oxygen. In the temperature range described above for the lightening process, the lightening of the pyrolysis gas is performed well, such that clogging and a differential pressure caused by wax can be suppressed.

Meanwhile, in the lightening process, a gas hourly space velocity (GHSV) may range from 0.3 to 1.2/hr or 0.5 to 0.8/hr. Accordingly, it is possible to lighten a waste plastic pyrolyzed product and reduce impurities (Cl and the like) without performing an additional post-treatment process, and it is possible to produce pyrolysis oil having the above-noted high proportion of light hydrocarbons and refined hydrocarbons having a high proportion of light hydrocarbons and solid coke by adjusting the GHSV of the pyrolysis gas.

The neutralizing agent filled in the hot filter may have a particle size of 400 to 900 μm, or may have a particle size of 500 to 800 μm. Under the operating conditions in one embodiment of the lightening process of the present disclosure, the hot filter is filled with the neutralizing agent having the particle size described above, such that lightening of the pyrolysis oil may be achieved by adjusting the GHSV of the pyrolysis gas, and process operation efficiency may be improved due to suppression of a differential pressure in the hot filter.

Meanwhile, the particle size may refer to D50, where D50 refers to a particle diameter when a cumulative volume from a small particle size accounts for 50% in measuring a particle size distribution by a laser scattering method. In this case, as for D50, the particle size distribution may be measured by collecting the sample from the prepared carbonaceous material according to KS A ISO 13320-1 standard using Mastersizer 3000 manufactured by Malvern Panalytical Ltd. Specifically, ethanol may be used as a solvent, and if necessary, the ethanol can be dispersed using an ultrasonic disperser, and then, a volume density may be measured.

According to another embodiment of the present disclosure, the hot filter may be filled with the beads and the neutralizing agent.

The hot filter generally serves to separate gas and a residue (char) among products in the pyrolysis process products such as those known in the art. However, in the present disclosure, a hot filter filled with at least one or more selected from the group consisting of beads and a neutralizing agent is applied for removal of impurities such as chlorine as well as lightening, and therefore, as described above, operating conditions such as a temperature of the hot filter and a particle size of the neutralizing agent can be adjusted to specific ranges.

The lightening process may satisfy the following Relational Expressions 1 and 2.

$$50 < ( {A}_{2} - {A}_{1} ) / {A}_{1} ( \% ) < 100 \qquad [ Relational Expression 1 ]$$

$$- 80 < ( {B}_{2} - {B}_{1} / {B}_{1} ) ( \% ) < - 50 \qquad [ Relational Expression 2 ]$$

In Relational Expression 1, A₁ represents a total amount (wt %) of naphtha (boiling point (bp) of 150° C. or lower) and kerosene (bp of 150 to 265° C.) of the pyrolysis gas, and A₂ represents a total amount (wt %) of naphtha (bp of 150° C. or lower) and kerosene (bp of 150 to 265° C.) of the pyrolysis oil, and in Relational Expression 2, B₁ represents a content (ppm) of chlorine in the pyrolysis gas, and B₂ represents a content (ppm) of chlorine in the pyrolysis oil.

Specifically, Relational Expressions 1 and 2 may be 60<(A₂-A₁)/A₁ (%)<90, 65< (A₂-A₁)/A₁ (%)<85, or 70< (A₂-A₁)/A₁ (%)<80, and −75<(B₂-B₁/B₁) (%)<−55, −70<(B₂-B₁/B₁) (%)<−55, or −65<(B₂-B₁/B₁) (%)<−55, respectively.

Relational Expressions 1 and 2 numerically represent degrees of lightness and heaviness of the waste plastic pyrolyzed products when the hot filter filled with at least one or more selected from the group consisting of beads and a neutralizing agent of the present disclosure is used. The present disclosure in one aspect has a technical feature of producing pyrolysis oil having the above-noted high proportion of light hydrocarbons by controlling the oil composition and the content of chlorine in the pyrolysis gas introduced into the hot filter and the organic/inorganic materials containing chlorine.

The pyrolysis oil produced in the lightening process may include, with respect to the total weight, 30 to 50 wt % of naphtha (bp of 150° C. or lower), 30 to 50 wt % of kerosene (bp of 150 to 265° C.), 10 to 30 wt % of light gas oil (LGO) (bp of 265 to 380° C.), and 0 to 10 wt % of UCO (Unconverted oil) 2/AR (Atmospheric residue) (bp of 380° C. or higher), and specifically, may include 35 to 50 wt % of naphtha (bp of 150° C. or lower), 35 to 50 wt % of kerosene (bp of 150 to 265° C.), 10 to 30 wt % of light gas oil (LGO) (bp of 265 to 380° C.), and 0 to 8 wt % of UCO-2/AR (bp of 380° C. or higher) or 35 to 45 wt % of naphtha (bp of 150° C. or lower), 35 to 45 wt % of kerosene (bp of 150 to 265° C.), 10 to 20 wt % of light gas oil (LGO) (bp of 265 to 380° C.), and 0 to 6 wt % of UCO-2/AR (bp of 380° C. or higher). In addition, in the pyrolysis gas, a weight ratio of light oils (the sum of naphtha and kerosene) to heavy oils (the sum of LGO and UCO-2/AR) may range from 2.5 to 5, 2.5 to 4, or 3 to 3.8.

In the pyrolysis oil produced in the lightening process, a total content of chlorine may be less than 100 ppm, 80 ppm or less, 60 ppm or less, 5 to 50 ppm, or 10 to 50 ppm, with respect to the total weight, and a content of organic chlorine may be less than 90 ppm, 70 ppm or less, 50 ppm or less, 5 to 50 ppm, or 5 to 40 ppm, with respect to the total weight.

According to another embodiment of the present disclosure, the pyrolysis process and the lightening process may satisfy the following Relational Expression 3.

$$0.7 < {T}_{2} / {T}_{1} < 1.3 \qquad [ Relational Expression 3 ]$$

In Expression 3, T₁ and T₂ are the respective temperatures at which the pyrolysis process and the lightening process are performed.

In a case where the pyrolysis process and the lightening process are performed so that the T₂/T₁ value satisfies 0.7 or less, the temperature of the pyrolysis process may be relatively high, or the temperature of the lightening process may be relatively low. In this case, a ratio of pyrolysis oil that is condensed in the hot filter and then circulated to the pyrolysis reactor increases, and thus, a final boiling point of the pyrolysis oil may be excessively low. On the other hand, the pyrolysis process and the lightening process are performed so that the T₂/T₁ value satisfies 1.3 or more, a loss ratio of the pyrolysis oil in a gas phase may excessively increase, and thus, the pyrolysis oil yield may be reduced.

Specifically, T₂/T₁ may range, for example, from 0.7 to 1.2, 0.8 to 1.2, 0.8 to 1.1, 0.9 to 1.1, or 1. Therefore, the effects described above may be further improved.

The dehydration process according to another embodiment of the present disclosure may be a process of dehydrating a first mixed solution obtained by mixing pyrolysis oil, washing water, and a demulsifier by applying a voltage to the first mixed solution.

The pyrolysis oil contains moisture, and moisture in pyrolysis oil may cause issues such as deactivation of a hydrotreating catalyst and corrosion of a reactor. In addition, since water-soluble impurities are contained in moisture, it is useful to remove moisture. Moisture present in the form of an emulsion in waste plastic pyrolysis oil may be removed by performing the dehydration process.

The pyrolysis oil according to another embodiment of the present disclosure may be a mixture of hydrocarbon oils produced by pyrolyzing waste plastics, and in this case, the waste plastics may include solid or liquid wastes related to synthetic polymer compounds such as waste synthetic resins, waste synthetic fibers, waste synthetic rubber, and waste vinyl.

The mixture of hydrocarbon oils according to another embodiment of the present disclosure may contain impurities such as a chlorine compound, a nitrogen compound, an oxygen compound, a metal compound, and char-derived particles, in addition to the hydrocarbon oils, may contain impurities in the form of compounds in which chlorine, nitrogen, oxygen, or a metal is bonded to hydrocarbons, and may contain paraffinic, olefinic, naphthenic, or aromatic hydrocarbons.

The washing water according to one embodiment of the present disclosure may serve to increase the probability of contact between emulsion-type moisture present in the pyrolysis oil. In addition, a basic compound may be added to the washing water to remove a water-soluble acidic material contained in moisture, and the basic compound may be sodium hydroxide (NaOH), but the present disclosure is not particularly limited thereto.

The plastic pyrolysis oil according to another embodiment of the present disclosure may be mixed in a greater volume than the washing water, and specifically, the pyrolysis oil and the washing water may be mixed in the first mixed solution at a volume ratio ranging from 1:0.001 to 0.5, more specifically, 1:0.005 to 0.4, and most specifically, 1:0.01 to 0.3. When the volume ratio satisfies the above range, water washing is sufficiently performed, and thus, impurities in the pyrolysis oil may be significantly reduced, and costs required to remove washing water to be mixed may be minimized.

The demulsifier according to one embodiment of the present disclosure may be one or a mixture of two or more selected from the group consisting of polyethylene glycol, tert-butanol, acetone, alkylnaphthalene sulfonate, alkylbenzene sulfonate, a nonionic alkoxylated alkyl phenol resin, polyalkylene oxide, and polyoxyethylene sorbitan ester, but is not limited thereto.

In the first mixed solution according to another embodiment of the present disclosure, the pyrolysis oil and the demulsifier may be mixed at a volume ratio ranging from 1:0.000001 to 0.001, specifically, 1:0.000002 to 0.0005, and more specifically, 1:0.000003 to 0.0001. When the volume ratio satisfies the above range, the emulsion may be decomposed with minimal impact on the quality of pyrolysis oil.

The demulsifier according to one embodiment of the present disclosure may have a weight average molecular weight ranging from 200 to 2,000, specifically, 300 to 1,000, and more specifically, 400 to 800. When the weight average molecular weight satisfies the above range(s), the demulsifier is mixable with the pyrolysis oil and the washing water under conditions where the dehydration process is performed, and thus, the decomposition efficiency of the moisture emulsion is increased.

The moisture in the form of an emulsion contained in the first mixed solution in which the pyrolysis oil, the washing water, and the demulsifier are mixed may still be difficult to remove because it is stable. Therefore, a voltage may be applied to the first mixed solution to facilitate removal of moisture.

The voltage according to another embodiment of the present disclosure may be applied as an alternating current or a combination of an alternating current (or voltage) and a direct current (or direct current voltage). Some impurity particles contained in the pyrolysis oil have polarities, and therefore, and when a direct current voltage is applied, polarized impurity particles are accumulated on a specific electrode, and when the process is performed for a long period of time, the impurities may adhere to the electrode. However, when an alternating current voltage is applied, the polarity of the electrode changes periodically, and therefore, the adhesion phenomenon of the impurity particles may be prevented. In addition, a frequency of the alternating current according to another embodiment of the present disclosure may be a single frequency or a combination of two or more frequencies. As a specific example, in the case of the single frequency, an alternating current (voltage) with a frequency of 60 Hz may be applied, and in the case of the combination of two or more frequencies, alternating currents (voltages) with frequencies of 50 Hz and 60 Hz may be applied alternately, but the present disclosure is not limited thereto.

The voltage according to another embodiment of the present disclosure may be applied through a vertical electrode. In a case where the impurity particles are accumulated on the electrode during a mixed solution preparation process or a voltage application process, and when the impurities particles are not artificially washed, the impurity particles may adhere to the electrode after a long period of time. However, when a vertical electrode is used, the adhesion phenomenon of the impurity particles may be prevented in advance because the impurity particles are not accumulated on the electrode but fall to the bottom of the reactor due to gravity even without an additional washing operation.

A magnitude of the voltage according to one embodiment of the present disclosure may range from 0.1 to 50 kV, specifically, 1 to 30 kV, and more specifically, 5 to 20 kV, but the present disclosure is not limited thereto.

The dehydration according to one embodiment of the present disclosure may be performed by any method known in the art. As a non-limiting example, after the application of the voltage, water may be removed by draining a water layer which is oil-Water separated. Water may also be removed in a gas-liquid water separator.

Metal impurities in the pyrolysis oil stabilize the emulsion, hinder oil-water separation, and help form a stable emulsion layer, commonly called a “rag” layer. Such a rag layer may be formed between a desalinated oil layer at an upper portion of the first mixed solution and a water layer at a lower portion of the first mixed solution, and may be gradually thickened during a continuous dehydration process. An excessively thickened rag layer may be discharged to an equipment at the hydrotreating process together with the desalinated oil. This reduces the desalination effect of the desalinated oil and reduces the efficiency of the process. In addition, the rag layer may be discharged together with water and may cause issues in a wastewater treatment process. Therefore, it is useful to remove the rag layer formed between the desalinated oil layer and the water layer.

Therefore, the method for producing refined hydrocarbons from waste plastics according to another embodiment of the present disclosure may further include, after the application of the voltage in the dehydration process, removing a rag layer from the first mixed solution. The removal of the rag layer may be performed through a pipe penetrating through a wall of a dehydrator 22 and connected to the outside after measuring a change in density of the mixed solution by a density meter in the dehydrator to determine a formation location and a thickness of the rag layer, but the present disclosure is not limited thereto.

In the dehydration process according to another embodiment of the present disclosure, after dehydrating the first mixed solution, the dehydrated first mixed solution may be additionally dehydrated by condensation of moisture.

The additional dehydration according to another embodiment of the present disclosure may be performed by supplying the dehydrated first mixed solution to a coalescer. Specifically, the residual moisture contained in the dehydrated first mixed solution may be removed through condensation by a collection filter in the coalescer, but this is only a specific example and the present disclosure is not limited thereto. As the content of moisture in the waste plastic pyrolysis oil is further reduced through the additional dehydration, deactivation of the catalyst due to moisture may be prevented, and the process stability and the quality of refined pyrolysis oil may be improved.

A ratio of a content of moisture in the pyrolysis oil to a content of moisture in the dehydrated first mixed solution according to another embodiment of the present disclosure may range from 1:0.0001 to 0.9, specifically, 1:0.0005 to 0.5, and more specifically, 1:0.001 to 0.1. When the ratio satisfies the above range(s), a risk of trouble occurring in subsequent processes such as hydrotreating may be significantly reduced, and high-quality refined pyrolysis oil that meets specifications may be produced as a feedstock for blending or for oil refining and petrochemical processes, but the present disclosure is not limited thereto.

The dehydration process according to one embodiment of the present disclosure may be performed at a pressure of 50 bar or less. When the dehydration process is performed at a pressure of 50 bar or less, moisture in the pyrolysis oil may be easily removed, and the process stability may be secured. Specifically, the dehydration process may be performed at a pressure of 30 bar or less, more specifically, 20 bar or less, and without limitation, 5 bar or more.

The dehydration process according to another embodiment of the present disclosure may be performed at a temperature ranging from 20° C. to 300° C. When the temperature satisfies the above range, the decomposition of the emulsion and the condensation of moisture are smoothly performed, and thus, the dehydration efficiency may be improved. Specifically, the dehydration process may be performed at a temperature ranging from 50° C. to 250° C., and more specifically, 80° C. to 200° C.

In order to improve the dehydration efficiency in the dehydration process according to another embodiment of the present disclosure, one or more additional processes selected from the group consisting of centrifugation and distillation May be performed before and/or after the dehydration. The additional processes described above may be performed by a method known in the art, but the present disclosure is not particularly limited thereto.

The hydrotreating process according to one embodiment of the present disclosure may be a process of hydrotreating a second mixed solution obtained by mixing the dehydrated first mixed solution with a sulfur source to produce refined pyrolysis oil from which impurities are removed.

The second mixed solution according to another embodiment 5 of the present disclosure may have a concentration of chlorine (Cl) of 10 ppm or more, specifically, 100 ppm or more, more specifically, 200 ppm or more, and without limitation, 3,000 ppm or less as an upper limit, but the present disclosure is not limited thereto.

In the second mixed solution according to another embodiment of the present disclosure, a weight ratio of nitrogen to chlorine may range from 1:0.1 to 10, specifically, 1:0.5 to 5, and more specifically, 1:1 to 2, but the above weight ratio is only a specific example of what may be included in the pyrolysis oil, and a composition of the pyrolysis oil is not limited thereto.

The hydrotreating according to one embodiment of the present disclosure may be performed under a condition in which a ratio of hydrogen to the second mixed solution may range from 100 Nm³/Sm³ to 5,000 Nm³/Sm³, specifically, 500 Nm³/Sm³ to 3,000 Nm³/Sm³, and more specifically, 1,000 Nm³/Sm³ to 1,500 Nm³/Sm³. When these ratios are satisfied, impurities may be effectively removed, the high activity of the hydrotreating catalyst may be maintained for a long period of time, and the process efficiency may be improved.

The sulfur source refers to a sulfur source capable of continuously supplying a sulfur component during the refining process.

In the hydrotreating process, the second mixed solution containing the sulfur source is prepared, such that during the refining process, deactivation of a molybdenum-based hydrotreating catalyst due to lack of the sulfur source and high-temperature operation may be suppressed, and the catalytic activity may be maintained.

The sulfur source according to one embodiment of the present disclosure may include sulfur-containing oil. The sulfur-containing oil refers to oil composed of hydrocarbons containing sulfur obtained from crude oil as a feedstock. The sulfur-containing oil is not particularly limited as long as it is oil containing sulfur, and the sulfur-containing oil may be, for example, light gas oil, straight-run naphtha, vacuum naphtha, pyrolysis naphtha, straight-run kerosene, vacuum kerosene, pyrolysis kerosene, straight-run gas oil, vacuum gas oil, pyrolysis gas oil, sulfur-containing waste tire oil, and any mixture thereof.

When waste tire oil is included as the sulfur-containing oil according to one embodiment of the present disclosure, a high content of sulfur contained in waste tires may be converted into oil together with hydrocarbons and may preferably serve as a sulfur source for the waste plastic pyrolysis oil. In addition, diverting the waste tire oil into the sulfur source for the waste plastic pyrolysis oil is advantageous in terms of reducing the environmental load due to recycling of waste tires and maintaining the catalytic activity for a long period of time.

Specifically, the sulfur-containing oil may be light gas oil (LGO) with a specific gravity ranging from 0.7 to 1. When this sulfur-containing oil is used, the sulfur-containing oil may be uniformly mixed with the dehydrated first mixed solution, and high hydrotreating efficiency may be exhibited.

Specifically, the specific gravity may range from 0.75 to 0.95, and more specifically, 0.8 to 0.9. The sulfur-containing oil may contain 100 ppm or more of sulfur. When the sulfur component is contained in an amount of less than 100 ppm, a content of the sulfur component supplied is small, such that the effect of preventing deactivation of the molybdenum-based hydrotreating catalyst may be insufficient. Specifically, the sulfur component may be contained in an amount of 800 ppm or more, more specifically, 8,000 ppm or more, and without limitation, 200,000 ppm or less.

The second mixed solution according to another embodiment of the present disclosure may contain 100 ppm or more of sulfur. As in the case of the sulfur-containing oil, when the sulfur component is contained in the second mixed solution in an amount of less than 100 ppm, the content of the sulfur component supplied is small, such that the effect of preventing deactivation of the molybdenum-based hydrotreating catalyst may be insufficient. Specifically, the sulfur component may be contained in an amount of 800 ppm or more, more specifically, 8,000 ppm or more, and without limitation, 200,000 ppm or less.

The sulfur-containing oil according to another embodiment of the present disclosure may be included in an amount of less than 0.5 parts by weight with respect to 100 parts by weight of the first mixed solution dehydrated in the dehydration process. Specifically, the sulfur-containing oil may be contained in an amount of less than 0.1 parts by weight, more specifically, less than 0.05 parts by weight, and without limitation, more than 0.01 parts by weight. As the sulfur-containing oil is included in an amount of less than 0.5 parts by weight, the concentration of chlorine (Cl) or nitrogen (N) contained in the waste plastic pyrolysis oil is diluted, such that a formation rate of an ammonium salt (NH₄Cl) may be controlled, and the process stability may be improved.

The sulfur source according to another embodiment of the present disclosure may include one or two or more sulfur-containing organic compounds selected from a disulfide-based compound, a sulfide-based compound, a sulfonate-based compound, and a sulfate-based compound. Specifically, the sulfur source may include one or a mixture of two or more selected from dimethyl disulfide, dimethyl sulfide, polysulfide, dimethyl sulfoxide (DMSO), methyl methanesulfonate, ethyl methanesulfonate, propyl methanesulfonate, propenyl propenesulfonate, propenyl cyanoethansulfonate, ethylene sulfate, bicyclo-glyoxal sulfate, and methyl sulfate. However, these compounds are only presented as examples and the present disclosure is not limited thereto.

The sulfur-containing organic compound according to another embodiment of the present disclosure may be included in an amount ranging from 0.01 to 0.1 parts by weight with respect to 100 parts by weight of the first mixed solution dehydrated in the dehydration process. Specifically, the sulfur-containing organic compound may be included in an amount ranging from 0.02 to 0.08 parts by weight, and more specifically, 0.03 to 0.06 parts by weight. When the sulfur-containing organic compound is included in an amount of less than 0.01 parts by weight, the content of the sulfur component supplied is small, such that the effect of preventing deactivation of the molybdenum-based hydrotreating catalyst may be insufficient.

The “hydrotreating” used herein refers to a hydrogenation reaction that occurs by adding a reaction gas including hydrogen gas (H₂) to the second mixed solution in which the first mixed solution dehydrated in the dehydration process and the sulfur source are mixed in the presence of a molybdenum-based hydrotreating catalyst. Specifically, the hydrotreating may refer to hydrotreating including a hydrodesulfurization reaction, a hydrocracking reaction, a hydrodechlorination reaction, a hydrodenitrogenation reaction, a hydrodeoxygenation reaction, and a hydrodemetallization reaction. Through the hydrotreating, impurities including chlorine (Cl), nitrogen (N), and oxygen (O), and some olefins may be removed, other metal impurities may also be removed, and a by-product containing the impurities is produced.

The by-product is produced by reacting impurities such as chlorine (Cl), nitrogen (N), sulfur(S), or oxygen (O) included in the waste plastic pyrolysis oil with hydrogen gas (H₂). Specifically, the by-product may include hydrogen sulfide gas (H₂S), hydrogen chloride (HCl), ammonia (NH₃), water vapor (H₂O), or the like, and in addition, may include unreacted hydrogen gas (H₂), and a trace of methane (CH₄), ethane (C₂H₆), propane (C₃H₈), butane (C₄H₁₀), or the like.

The molybdenum-based hydrotreating catalyst according to another embodiment of the present disclosure may be a catalyst in which a molybdenum-based metal, or a metal including one or two or more selected from nickel, cobalt, and tungsten, and a molybdenum-based metal supported on a support. The molybdenum-based hydrotreating catalyst has high catalytic activity during hydrotreating, and the molybdenum-based hydrotreating catalysts may be used alone or, if necessary, in the form of a two-way catalyst combined with a metal such as nickel, cobalt, or tungsten.

As the support according to one embodiment of the present disclosure, alumina, silica, silica-alumina, titanium oxide, a molecular sieve, zirconia, aluminum phosphate, carbon, niobia, or a mixture thereof may be used with the catalyst, but the present disclosure is not limited thereto.

The molybdenum-based hydrotreating catalyst according to another embodiment of the present disclosure may include a molybdenum-based sulfide hydrotreating catalyst. For example, the molybdenum-based hydrotreating catalyst may include molybdenum sulfide (MOS) or molybdenum disulfide (MOS₂), but the present disclosure is not limited thereto, and may include known molybdenum-based sulfide hydrotreating catalysts.

The reaction gas according to another embodiment of the present disclosure may further include hydrogen sulfide gas (H₂S). The hydrogen sulfide gas (H₂S) included in the reaction gas may act as a sulfur source, and may regenerate the activity of the molybdenum-based hydrotreating catalyst deactivated during the refining process together with the sulfur source mixed with the waste plastic pyrolysis oil.

The hydrotreating according to one embodiment of the present disclosure may be performed at a pressure of 150 bar or less. Specifically, the hydrotreating may be performed at a pressure of 120 or less, more specifically, 100 bar or less, and without limitation, 50 bar or more. When the hydrotreating is performed under a pressure condition of more than 150 bar, as ammonia and hydrogen chloride are produced in excess during the hydrotreating, an ammonium salt formation temperature increases, and as a result, a differential pressure of a reactor or the like in the process may be easily caused, and the process stability may be significantly reduced. By controlling the content of nitrogen and chlorine in the waste plastic pyrolysis oil, the increase in ammonium salt formation temperature may be partially suppressed even under a condition of a pressure of more than 150 bar. However, this case is not appropriate because the waste plastic pyrolysis oil targeted in the refining process according to the present disclosure may be extremely limited thereto.

The hydrotreating according to another embodiment of the present disclosure may be performed at a temperature ranging from 150° C. to 500° C. When the temperature satisfies the above range, the hydrotreating efficiency may be improved.

Specifically, the hydrotreating may be performed at a temperature ranging from 200° C. to 400° C.

The hydrotreating according to one embodiment of the present disclosure may be performed in multiple stages, and as a specific example, may be performed in two stages. When the hydrotreating is performed in two stages, the first stage may be performed at a lower temperature than the second stage. In this case, the first stage may be performed at a temperature ranging from 150° C. to 300° C., and specifically, 200° C. to 250° C., and the second stage may be performed at a temperature ranging from 300° C. to 500° C., and specifically, 350° C. to 400° C., but the present disclosure is not limited thereto.

The hydrotreating according to one embodiment of the present disclosure may be performed at a liquid hourly space velocity (LHSV) ranging from 0.1 to 5 h⁻¹. When the LHSV satisfies the above range, refined pyrolysis oil from which impurities such as chlorine, nitrogen, and metals are removed may be more stably obtained as compared to operating outside this range. Specifically, the hydrotreating may be performed at an LHSV ranging from 0.3 to 3 h⁻¹, and more specifically, 0.5 to 1.5 h⁻¹.

The method for producing refined hydrocarbons from waste plastics according to another embodiment of the present disclosure may further include, after the hydrotreating process, subjecting a stream including the refined pyrolysis oil from which impurities are removed to gas-liquid separation and then washing the gas-liquid separated stream with water.

The stream including the refined pyrolysis oil from which impurities are removed according to another embodiment of the present disclosure may contain hydrogen chloride, ammonia, unreacted hydrogen gas, and the like, in addition to the refined pyrolysis oil from which impurities are removed for example discharged from a rear end of the reactor where the hydrotreating process is performed.

Through the gas-liquid separation according to another embodiment of the present disclosure, from the stream including the refined pyrolysis oil from which impurities are removed, ammonia and hydrogen chloride produced by the hydrotreating may be removed, and unreacted hydrogen gas may be recovered.

The gas-liquid separation according to another embodiment of the present disclosure may be performed by a method known in the art using a separator, but is not particularly limited thereto.

The gas-liquid separation according to another embodiment of the present disclosure may be performed two to four times, specifically, three or four times, and more specifically, four times. When the above range is satisfied, the formation of the ammonium salt may be minimized even under a low-temperature condition for oil-water separation because the refined pyrolysis oil contains traces of NH₃ and hydrogen chloride. In addition, oil refining and petrochemical processes using the refined oil as a feedstock may be stably performed without the need to add an additional salt remover to the refined pyrolysis oil later.

A gas stream produced as a result of the gas-liquid separation according to one embodiment of the present disclosure may include off-gas containing light hydrocarbons, hydrogen sulfide, ammonia, hydrogen chloride, or the like, and unreacted hydrogen gas. According to a method known in the art, the off-gas and the unreacted hydrogen gas are separated, and the separated unreacted hydrogen gas is recirculated in the process, and the off-gas is treated through a process described below and may be used as fuel or discharged into the atmosphere.

Through the water washing according to another embodiment of the present disclosure, a salt included in the gas stream may be dissolved and removed, or salt formation may be suppressed by dissolving gas that may form a salt. The water washing may be performed by a method known in the art, but the present disclosure is not particularly limited thereto.

The water washing according to another embodiment of the present disclosure may be performed two to four times, and specifically, two or three times. When the above range is satisfied, the salt removal and salt formation suppression effect may be sufficiently exhibited, such that high-quality refined pyrolysis oil may be obtained, and the process stability may be secured.

The method for producing refined hydrocarbons from waste plastics according to another embodiment of the present disclosure may further include, after the subjecting of the stream including the refined pyrolysis oil from which impurities are removed to the gas-liquid separation and then the washing of the gas-liquid separated stream with water: combusting the separated off-gas; and processing uncombusted off-gas.

The off-gas according to another embodiment of the present disclosure may contain C1-C4 light hydrocarbons, hydrogen sulfide (H₂S), ammonia (NH₃), and the like. Therefore, in order to use the off-gas as fuel meeting emission standards, it is required to combust the off-gas to remove hydrogen sulfide (H₂S), ammonia (NH₃), and the like before exhausting. In other words, exhaust gas containing sulfur dioxide (SO₂), nitrogen dioxide (NO₂), and the like, produced by combustion of the off-gas may be discharged into the atmosphere after performing caustic scrubbing to meet emission standards.

In addition, after the combusting of the separated off-gas, uncombusted off-gas may be discharged as wastewater by being subjected to sour water stripping, adsorption, biological treatment, oxidation, amine scrubbing, or caustic scrubbing. ‘Sour water’ means water containing at least one selected from the group consisting of NH3, H2S and CO2.

The method for producing refined hydrocarbons from waste plastics according to another embodiment of the present disclosure may include a coking process. In particular, since the coking process is included, refined hydrocarbons having a high proportion of light hydrocarbons and solid coke may be obtained from waste plastics, such that the cost efficiency of the process may be improved.

The “coking” in the present disclosure generally refers to a delayed coking process used to convert crude oil residues such s atmospheric residue and vacuum residue, which are residues that remain at the bottom of a distillation column during atmospheric and vacuum distillation of crude oil.

In the coking process according to one embodiment of the present disclosure, a fired heater or a furnace may be used.

A temperature in the coking process may be 425° C. or higher, 450° C. or higher, 470° C. or higher, 700° C. or lower, 650° C. or lower, 600° C. or lower, 550° C. or lower, 500° C. or lower, or a value between the above numerical values, and specifically, 425 to 700° C. or 450 to 550° C., but the present disclosure is not limited thereto.

A pressure in the coking process may range from 1 to 20 bar, specifically, 1 to 10 bar, and more specifically, 1 to 5 bar.

In addition, the contents described in the pyrolysis process may be applied to the coking process.

In one embodiment of the present disclosure, the refined pyrolysis oil may be mixed with petroleum hydrocarbons and coked as a mixed oil.

In the coking process according to another embodiment of the present disclosure, a refined fraction (separated by distilling the refined pyrolysis oil from which impurities are removed) may be coked. The refined fraction according to one embodiment of the present disclosure may be at least one or more selected from the group consisting of naphtha, kerosene, light gas oil, heavy gas oil (HGO), vacuum gas oil (VGO), atmospheric residue, and vacuum residue, but the present disclosure is not limited thereto.

In the coking process according to another embodiment of the present disclosure, the mixed oil obtained by mixing the refined pyrolysis oil (from which impurities are removed) and petroleum hydrocarbons may be coked. In addition, mixed oil obtained by mixing the refined pyrolysis oil and petroleum hydrocarbons may also be coked.

The petroleum hydrocarbon refers to a mixture of naturally occurring hydrocarbons or a compound separated from the mixture. Specifically, the petroleum hydrocarbon may be at least one or more selected from the group consisting of crude oil and hydrocarbons derived from crude oil, but the present disclosure is not limited thereto.

The mixed oil according to another embodiment of the present disclosure may include the refined pyrolysis oil in an amount of 5 wt % or more, 10 wt % or more, 20 wt % or more, 40 wt % or more, or 50 wt % or more, with respect to the total weight of the mixed oil, and an upper limit of the content of the refined pyrolysis oil may be 95 wt % or less or 90 wt % or less, but is not limited thereto. The present disclosure is not limited to the above range. However, in general, the lower the content of impurities in the pyrolysis oil, the higher the proportion of pyrolysis oil that may be included in the mixed oil.

The method for producing refined hydrocarbons from waste according to another embodiment of the present disclosure may further include, after the lightening process or the hydrotreating process, a distillation process of distilling the refined pyrolysis oil.

In the method for producing refined hydrocarbons from waste plastics according to another embodiment of the present disclosure, hydrocarbons derived from the refined pyrolysis oil separated in the distillation process and petroleum hydrocarbons may be mixed and coked as mixed oil.

According to another embodiment of the present disclosure, in the distillation process, the refined pyrolysis oil may be distilled to obtain refined hydrocarbons in the form of naphtha at a boiling point of 150° C. or lower, kerosene at a boiling point of 150 to 265° C., light gas oil (LGO) at a boiling point of 265 to 340° C., and vacuum gas oil (VGO) at a boiling point of 340° C. or higher. In addition, in the distillation process, the refined pyrolysis oil may be distilled to obtain atmospheric residue having a boiling point of 380° C. or higher.

The method for producing refined hydrocarbons from waste plastics according to one embodiment of the present disclosure may further include a distillation process, but the present disclosure is not limited thereto, and may include, but is not limited to, processes applicable in an oil refining process or a petrochemical process.

According to another embodiment of the present disclosure, the distillation may be performed in at least one or more processes selected from the group consisting of crude distillation and vacuum distillation.

In addition, the present disclosure in one embodiment provides a system for producing refined hydrocarbons from waste plastics.

The contents described for the method for producing refined hydrocarbons from waste plastics may be equally applied to the description of the system for producing refined hydrocarbons from waste plastics to the extent of overlap.

The present disclosure in one embodiment provides a system for producing refined hydrocarbons from waste plastics, the system including: a pretreatment device for pretreating waste plastics; a pyrolysis reactor for producing a pyrolysis gas by introducing the waste plastics pretreated in the pretreatment device; a hot filter for producing a pyrolysis oil by introducing the pyrolysis gas; a connection pipe connecting the hot filter and the pyrolysis reactor so that a liquid condensed in the hot filter can be re-introduced into the pyrolysis reactor; a dehydration device for dehydrating a first mixed solution, obtained by mixing the produced pyrolysis oil with washing water and a demulsifier, by applying a voltage to the first mixed solution; a hydrotreating device for hydrotreating a second mixed solution obtained by mixing the dehydrated first mixed solution with a sulfur source to produce a refined pyrolysis oil from which impurities are removed; and a coking device for coking the refined pyrolysis oil.

The system of the present disclosure in one embodiment may produce high-value-added oil having the above-noted high proportion of light hydrocarbons from waste plastics containing a large amount of impurities, and may produce refined hydrocarbons having a high proportion of light hydrocarbons and solid coke therefrom. In addition, the system of the present disclosure may improve a yield of the pyrolysis oil obtained from waste plastics.

Referring to FIG. 2, a feedstock 11 may be injected into a feedstock injection part 12, and screw-mixing may be performed. The crushed waste plastics and additives may be introduced into a pretreatment reactor 13, and then pretreatment may be performed. The pretreated waste plastics may be introduced into a pyrolysis reactor 14 and pyrolysis may be performed to produce pyrolysis gas. The produced pyrolysis gas may be introduced into a hot filter 15 and then lightened. Thereafter, the lightened pyrolysis gas may flow into a condenser 16, and pyrolysis oil may be obtained in a pyrolysis oil recovery section 18. A liquid condensed in the hot filter 15 may be re-introduced into the pyrolysis reactor 14 through the connection pipe 19. And then the pyrolysis oil or mixed oil obtained by mixing the pyrolysis oil and oil derived from crude oil may be coked in the coking device 26.

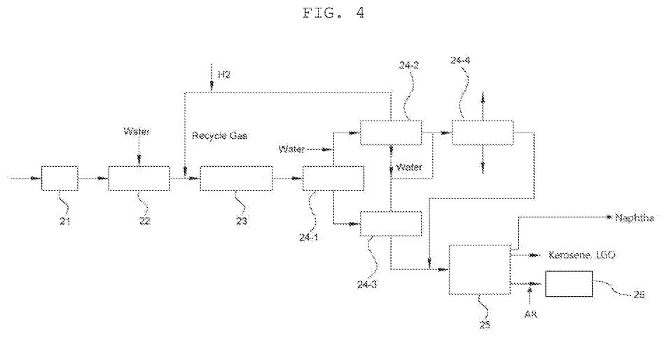

Referring to FIG. 4, the pyrolysis oil obtained from a feed tank 21 may be introduced into a dehydrator 22 and stirring may be performed to prepare a first mixed solution. The first mixed solution may be separated into oil and water by applying an alternating current voltage through a vertical electrode. Thereafter, dehydration may be performed by removing the separated water layer. The first mixed solution dehydrated in the dehydrator 22 may be mixed with dimethyl disulfide to prepare a second mixed solution, and then the second mixed solution may be hydrotreated in a hydrotreating device 23. Thereafter, the hydrogenated pyrolysis oil may be introduced into a first separator 24-1, and liquid and gas may be separated from the hydrogenated pyrolysis oil. The liquid separated in the first separator 24-1 may flow into a third separator 24-3 and then may flow into a fractionator 25. The gas separated in the first separator 24-1 may flow into a second separator 24-2. Impurities including NH₃ and HCl contained in the gas separated in the first separator 24-1 may be removed together with water in the second separator 24-2. After additional separation is performed in a fourth separator 24-4, oil recovered from the gas may flow into fractionator 25, and refined pyrolysis oil from which the impurities are removed may be produced. Mixed oil obtained by mixing oil derived from refined pyrolysis oil separated by distilling the refined pyrolysis oil in the fractionator 25 and at least one or more selected from the group consisting of atmospheric residue (AR) and vacuum residue (VR) may be introduced into a coking device 26, and coking may be performed.

According to one embodiment of the present disclosure, the hot filter may be filled with beads. When the hot filter is filled with beads, an inert effect and a heat transfer effect in the hot filter are maximized, which makes it possible to produce pyrolysis oil having the above-noted high proportion of light hydrocarbons. In addition, the pyrolysis oil yield may be improved.

According to one embodiment of the present disclosure, the beads may include at least one or more selected from the group consisting of silica sand (SiO₂) and aluminum oxide (Al₂O₃).

According to another embodiment of the present disclosure, the system may further include at least two heaters provided outside the hot filter. In addition, the system may include at least three heaters outside the hot filter. When at least two heaters are provided outside the hot filter, a temperature gradient of the hot filter may be formed, and the temperatures at the top, middle, and bottom of the hot filter may be adjusted depending on operating conditions of the hot filter, such that a flexible process operation may be performed.

The dehydrator according to another embodiment of the present disclosure may be provided with a vertical electrode. The number of vertical electrodes provided in the dehydrator according to one embodiment of the present disclosure may be at least two, specifically, four or more, more specifically, six or more, and as an upper limit, twenty or fewer, but the present disclosure is not limited thereto.

The dehydrator according to another embodiment of the present disclosure may include a coalescer therein. The coalescer is a device that collects fine droplets to form large droplets, and any device commonly used in the industry may be used. The coalescer is not particularly limiting.

The first mixed solution dehydrated in the dehydrator may be introduced into the coalescer according to another embodiment of the present disclosure, and an additionally dehydrated first mixed solution may be produced. When a dehydrator including the coalescer is used, the additionally dehydrated first mixed solution is introduced into the hydrotreating reactor together with the hydrogen gas.

The system for producing refined hydrocarbons from waste plastics according to another embodiment of the present disclosure may further include a separator for subjecting the refined pyrolysis oil from which impurities are removed to gas-liquid separation, the refined pyrolysis oil being produced in the hydrotreating reactor.

The number of separators according to another embodiment of the present disclosure may be two to four, specifically, three or four, and more specifically, four. When the above range is satisfied, the formation of the ammonium salt may be minimized even under a low-temperature condition for oil-water separation because the refined pyrolysis oil contains traces of NH₃ and hydrogen chloride. In addition, oil refining and petrochemical processes using the refined pyrolysis oil as a feedstock may be stably performed without adding an additional salt remover to the refined pyrolysis oil later.

The system for producing refined hydrocarbons from waste plastics according to one embodiment of the present disclosure may further include a recycle gas compressor recovering unreacted hydrogen gas from the separated gas stream from the separator and adding the recovered unreacted hydrogen gas to the hydrotreating reactor.

Hereinafter, examples of the present disclosure will be further described with reference to specific experimental examples. The examples and comparative examples included in the experimental examples are merely illustrative of the present disclosure, and various modifications and alterations may be made without departing from the scope of the present disclosure.

In the present specification, as used herein, the term “pyrolysis oil yield” refers to a weight ratio of oil produced to the total weight of the oil produced, any aqueous by-product, any pyrolysis residue (char), and any by-product gas (among the products in the pyrolysis process).

### Example 1

78.8 wt % of PE, 11.6 wt % of PP, 3.1 wt % of PVC, 2.4 wt % of PET, 2.1 wt % of nylon, and 2.0 wt % of PU were contained in industrial waste plastics used as a feedstock.

1,020 g of the industrial waste plastic feedstock was injected into a feedstock injection port and screw-mixing was performed. The crushed waste plastics and CaO were introduced into an auger reactor at 200 g/hr and 10 g/hr, respectively, and then a pretreatment was performed at a screw speed of 10 rpm, a nitrogen flow rate of 3 cc/min, 300° C., and a gas hourly space velocity (GHSV) of 1/hr.

The pretreated waste plastics were introduced into a rotary kiln batch pyrolysis reactor, and pyrolysis was performed at a rotary kiln rotation speed of 4 rpm and 430° C., thereby producing pyrolysis gas.

The produced pyrolysis gas was introduced into a 1.3 L hot filter not filled with glass beads and then lightened, and then pyrolysis oil was obtained in a recovery section. A liquid condensed in the hot filter was re-introduced into the pyrolysis reactor. The pyrolysis oil yield is shown in Table 1.

The obtained pyrolysis oil, washing water, and polyethylene glycol having a weight average molecular weight of 500 were added to a dehydrator under conditions of 150° C. and 10 bar at a volume ratio of 1:0.25:0.0001, and stirring was performed, thereby preparing a first mixed solution. The first mixed solution was separated into oil and water by applying an alternating current voltage of 15 kV through a vertical electrode, and then dehydration was performed by removing the water layer.

At this time, in the dehydrator, high concentrations of impurities contained in the pyrolysis oil, such as about 5,000 ppm or more of moisture, 500 ppm or more of nitrogen (N), 200 ppm or more of chlorine (Cl), and 20 vol % or more of olefins, were treated.

A second mixed solution was prepared by mixing dimethyl disulfide in an amount of 0.04 parts by weight with respect to 100 parts by weight of the first mixed solution dehydrated in the dehydrator, and then the second mixed solution was hydrotreated under conditions of 300° C. and 70 bar, thereby producing refined pyrolysis oil from which impurities were removed.

The result of GC-Simdis analysis (HT 750) to confirm the molecular weight distribution of the refined pyrolysis oil is shown in Table 2, and the measurement result of the impurity content in the refined pyrolysis oil is shown in Table 3-1 and 3-2.

Mixed oil obtained by mixing the refined pyrolysis oil and atmospheric residue having a boiling point of 380° C. or higher derived from crude oil at a weight ratio of 2:8 was introduced into a furnace, and coking was performed under conditions of 480° C. and 4 bar, thereby obtaining refined hydrocarbons including naphtha and kerosene and solid coke.

### Example 2

A process was performed in the same manner as that of Example 1, except that a 1.3 L hot filter was filled with glass beads having a diameter of 3 mm at 88 vol % with respect to the internal volume of the hot filter, and the top temperature, the middle temperature, and the bottom temperature of the hot filter were maintained at 430° C.

### Example 3

A process was performed in the same manner as that of Example 1, except that a 1.3 L hot filter was filled with glass beads having a diameter of 3 mm at 88 vol % with respect to the internal volume of the hot filter, the top temperature of the hot filter was maintained at 430° C., and the middle temperature and the bottom temperature of the hot filter were maintained at 500° C.

### Example 4

A process was performed in the same manner as that of Example 1, except that a 1.3 L hot filter was filled with glass beads having a diameter of 3 mm at 88 vol % with respect to the internal volume of the hot filter, the top temperature of the hot filter was maintained at 430° C., the middle temperature of the hot filter was maintained at 450° C., and the bottom temperature of the hot filter was maintained at 500° C.

### Examples 5 and 6

Refined pyrolysis oil from which impurities were removed was produced under the same conditions as those in Example 1, except that the waste plastic pyrolysis oil, washing water, and polyethylene glycol were added to the dehydrator at the volume ratio shown in Table 1 in Example 1.

### Example 7

Refined pyrolysis oil from which impurities were removed was produced under the same conditions as those in Example 1, except that a direct current voltage was applied through a horizontal electrode in Example 1.

### Example 8

Refined pyrolysis oil from which impurities were removed was produced under the same conditions as those in Example 1, except that the dehydration of the first mixed solution was performed under a temperature condition of 120° C. in Example 1.

### Example 9

Refined pyrolysis oil from which impurities were removed was produced under the same conditions as those in Example 1, except that the waste plastic pyrolysis oil and polyethylene glycol were added at a volume ratio of 1:0.00001 in Example 8 and the hydrotreating was performed under a condition of a pressure of 180 bar.

### Example 10

Refined pyrolysis oil from which impurities were removed was produced under the same conditions as those in Example 1, except that after the first mixed solution was dehydrated, the first mixed solution was additionally dehydrated through a coalescer in Example 1.

### Example 11

A process was performed in the same manner as that of Example 1, except that mixed oil obtained by mixing atmospheric residue having a boiling point of 380° C. or higher derived from refined pyrolysis oil separated by distilling the refined pyrolysis oil and atmospheric residue having a boiling point of 380° C. or higher derived from crude oil at a weight ratio of 2:8 was used.

### Comparative Example 1

A process was performed in the same manner as that of Example 1, except that the liquid condensed in the hot filter was not re-introduced into the pyrolysis reactor.

### Comparative Example 2

Refined pyrolysis oil from which impurities were removed was produced under the same conditions as those in Example 1, except that washing water was not added in Example 1.

### Comparative Example 3

Refined pyrolysis oil from which impurities were removed was produced under the same conditions as those in Example 1, except that polyethylene glycol was not added in Example 1.

### Comparative Example 4

Refined pyrolysis oil from which impurities were removed was produced under the same conditions as those in Example 1, except that a voltage was not applied in Example 1.

### Comparative Example 5

Refined pyrolysis oil from which impurities were removed was produced under the same conditions as those in Example 1, except that dimethyl disulfide was not mixed with the dehydrated first mixed solution in Example 1.

### Evaluation Examples

### Measurement Methods

The composition of the waste plastic feedstock was analyzed using Flake analyzer available from RTT System GmbH, Germany, among NIR analyzers.

GC-Simdis analysis (HT 750) was performed to confirm the composition of pyrolyzed products related to pyrolysis oil yield measurement.

In order to analyze the contents of moisture and impurities such as Cl, S, N, and O in the mixed solution obtained after the dehydration process was completed and the contents of impurities such as Cl, S, N, and O in the finally obtained refined pyrolysis oil, ICP, TNS, EA-O, and XRF analysis were performed. The total content of Cl was measured according to ASTM D5808, the content of N was measured according to ASTM D4629, and the content of S was measured according to ASTM D5453.

The catalytic activity duration was measured and expressed in hours based on the time point when the content of nitrogen in the refined pyrolysis oil exceeded 10 ppm by performing Total Nitrogen & Sulfur (TNS element) analysis on the refined pyrolysis oil.

In addition, the process of each of Examples and Comparative Examples was operated for three months, and a particle adhesion rate was measured according to the following Equation 1.

### Equation 1

Particle adhesion rate (%)=(Amount of impurity particles adhering to electrode/Amount of impurity particles in pyrolysis oil)×100

TABLE 1

| | Comparative | Example | Example | Example | Example |
|---|---|---|---|---|---|
| | Example 1 | 1 | 2 | 3 | 4 |
| Pyrolysis | 52.1 | 55.1 | 57.0 | 60.8 | 62.4 |
| oil yield | | | | | |
| (wt %) | | | | | |

TABLE 2

| Refined pyrolysis | | | | | |
|---|---|---|---|---|---|
| oil composition | Comparative | Exam- | Exam- | Exam- | Exam- |
| ratio (wt %) | Example 1 | ple 1 | ple 2 | ple 3 | ple 4 |
| Naphtha (boiling | 26.9 | 32.5 | 40.5 | 45.5 | 45.7 |
| point of 150° C. | | | | | |
| or lower) | | | | | |
| Kerosene (boiling | 32.5 | 35.5 | 33.6 | 39.4 | 41.8 |
| point of 150 to | | | | | |
| 265° C.) | | | | | |
| LGO (boiling | 21.0 | 17.8 | 13.0 | 7.8 | 8.1 |
| point of 265 to | | | | | |
| 340° C.) | | | | | |
| VGO (boiling | 19.6 | 14.2 | 12.9 | 7.3 | 4.4 |
| point of 340° C. | | | | | |
| or higher) | | | | | |
| Total of naphtha | 59.4 | 68.0 | 74.1 | 84.9 | 87.5 |
| and kerosene | | | | | |

In Comparative Example 1 in which the hot filter was not filled with beads and the liquid condensed in the hot filter was not re-introduced into the pyrolysis reactor, the pyrolysis oil yield and the proportion of light oil including naphtha and kerosene were the lowest.

In the case of Example 1 in which the liquid condensed in the hot filter was re-introduced into the pyrolysis reactor, an excellent pyrolysis oil yield and an excellent proportion of light hydrocarbons including naphtha and kerosene were achieved compared to Comparative Example 1.

In Example 2 in which the liquid condensed in the hot filter was re-introduced into the pyrolysis reactor and the hot filter was filled with beads, the pyrolysis oil yield and the proportion of light hydrocarbons including naphtha and kerosene were superior to those in Example 1.

In Examples 3 and 4 in which the liquid condensed in the hot filter was re-introduced into the pyrolysis reactor, the hot filter was filled with beads, and a temperature gradient was formed in the hot filter, the pyrolysis oil yield and the proportion of light hydrocarbons including naphtha and kerosene were superior to those in Examples 1 and 2.

In particular, in Example 4 in which the top temperature, the middle temperature, and the bottom of the hot filter were maintained at 430° C., 450° C., and 500° C., respectively, the pyrolysis oil yield and the proportion of light hydrocarbons including naphtha and kerosene were the best.

In addition, the measurement results of the contents of impurities in the refined pyrolysis oil according to Examples and Comparative Examples are shown in Table 3-1 and 3-2.

TABLE 3-1

| | | | Example 1 | Example 5 | Example 6 | Example 7 | Example 8 | Example 9 | Example 10 |
|---|---|---|---|---|---|---|---|---|---|
| Dehydration | Washing water | | 0.25 | 0.50 | 0.25 | 0.25 | 0.25 | 0.25 | 0.25 |
| | (volume ratio) | | | | | | | | |
| | Demulsifier | | 0.0001 | 0.0001 | 0.00001 | 0.0001 | 0.0001 | 0.00001 | 0.0001 |
| | (volume ratio) | | | | | | | | |
| | Temperature | | 150 | 150 | 150 | 150 | 120 | 120 | 150 |
| | (° C.) | | | | | | | | |
| | Pressure | | 10 | 10 | 10 | 10 | 10 | 10 | 10 |
| | (bar) | | | | | | | | |
| | Voltage | Type | AC | AC | AC | DC | AC | AC | AC |
| | | Electrode | Vertical | Vertical | Vertical | Horizontal | Vertical | Vertical | Vertical |

| | | | | | | | | |
|---|---|---|---|---|---|---|---|---|
| | Presence or absence of | X | X | X | X | X | X | ◯ |
| | coalescer | | | | | | | |
| Hydrotreating | Whether sulfur | ◯ | ◯ | ◯ | ◯ | ◯ | ◯ | ◯ |
| | source is mixed | | | | | | | |
| | or not | | | | | | | |
| | Temperature | 300 | 300 | 300 | 300 | 300 | 300 | 300 |
| | (° C.) | | | | | | | |
| | Pressure | 70 | 70 | 70 | 70 | 70 | 180 | 70 |
| | (bar) | | | | | | | |

| | | | | | | | |
|---|---|---|---|---|---|---|---|
| Content of moisture after | 592 | 783 | 672 | 595 | 721 | 895 | 510 |
| dehydration | | | | | | | |
| (ppm) | | | | | | | |
| Content of Cl after | 126 | 123 | 137 | 125 | 144 | 165 | 108 |
| dehydration | | | | | | | |
| (ppm) | | | | | | | |
| Content of N after | 836 | 814 | 858 | 839 | 866 | 947 | 770 |
| dehydration | | | | | | | |
| (ppm) | | | | | | | |
| Catalytic activity | >720 | >720 | >720 | >720 | >720 | >720 | >720 |
| duration | | | | | | | |
| (hr) | | | | | | | |
| Content of Cl in refined | <1 | <1 | <1 | <1 | <1 | <1 | <1 |
| pyrolysis oil | | | | | | | |
| (ppm) | | | | | | | |
| Content of N in refined | <1 | <1 | <1 | <1 | <1 | <1 | <1 |
| pyrolysis oil | | | | | | | |
| (ppm) | | | | | | | |
| Particle adhesion rate | 0.20 | 0.18 | 0.20 | 3.5 | 0.21 | 0.20 | 0.18 |
| (%) | | | | | | | |

TABLE 3-2

| | | | Comparative | Comparative | Comparative | Comparative |
|---|---|---|---|---|---|---|
| | | | Example 2 | Example 3 | Example 4 | Example 5 |
| Dehydration | Washing water | | — | 0.25 | 0.25 | 0.25 |
| | (volume ratio) | | | | | |
| | Demulsifier | | 0.0001 | — | 0.0001 | 0.0001 |
| | (volume ratio) | | | | | |
| | Temperature (° C.) | | 150 | 150 | 150 | 150 |
| | Pressure (bar) | | 10 | 10 | 10 | 10 |
| | Voltage | Type | AC | AC | — | AC |
| | | Electrode | Vertical | Vertical | — | Vertical |

| | | | | | |
|---|---|---|---|---|---|
| | Presence or absence | X | X | X | X |
| | of coalescer | | | | |
| Hydrotreating | Whether sulfur source | ◯ | ◯ | ◯ | X |
| | is mixed or not | | | | |
| | Temperature (° C.) | 300 | 300 | 300 | 300 |
| | Pressure (bar) | 70 | 70 | 70 | 70 |

| | | | | |
|---|---|---|---|---|
| Content of moisture after dehydration (ppm) | 2485 | 4416 | 3840 | 610 |
| Content of Cl after dehydration (ppm) | 229 | 250 | 247 | 126 |
| Content of N after dehydration (ppm) | 1049 | 1100 | 1090 | 847 |
| Catalytic activity duration (hr) | <576 | <576 | <576 | <336 |
| Content of Cl in refined pyrolysis oil (ppm) | 4.4 | 5.9 | 4.7 | 3.2 |
| Content of N in refined pyrolysis oil (ppm) | 11.4 | 14.5 | 12.4 | 11 |
| Particle adhesion rate (%) | 0.24 | 0.21 | — | 0.20 |

As shown in Table 3-1 and 3-2, in Comparative Examples 2 to 4, the addition of washing water, addition of demulsifier, and application of voltage were set differently from Examples, and as a result, moisture and Cl removal was poor. Accordingly, the catalyst was adversely affected in the hydrotreating process, and the content of Cl in the finally obtained refined pyrolysis oil was high. In Comparative Example 5, although moisture and some impurities in the pyrolysis oil were sufficiently removed in the dehydration process, the hydrotreating catalyst was deactivated within a short time due to an insufficient content of sulfur, and thus, when the refining process was maintained for a long period of time, the content of Cl in the refined pyrolysis oil was high as in other Comparative Examples.

However, in Examples 1 and 5 to 10 of the present disclosure, a significant amount of moisture contained in the pyrolysis oil was removed through the dehydration process, and a sulfur source was added, and as a result, the activity of the hydrotreating catalyst was maintained for a remarkably long time. In addition, as some water-soluble impurities were preemptively removed in the dehydration process and the excellent activity of the catalyst was maintained for a long period of time, high-quality refined pyrolysis oil having a significantly low content of impurities was obtained.

Meanwhile, when an alternating voltage was applied using a vertical electrode, the adhesion rate of impurity particles derived from char in the pyrolysis oil to the electrode surface was significantly low even when the process was continued for longer than three months. Through this, when an alternating current voltage was applied or a vertical electrode was used, there was no need to stop the process for washing the inside of the reactor, and as a result, the process efficiency improved.

In addition, in the case of Example 9, although the dehydration result was poor compared to other Examples, the content of Cl impurities in the refined pyrolysis oil was substantially lower as the hydrotreating was performed under a high pressure condition. However, since ammonia and hydrogen chloride were produced in excess due to the high pressure, a relatively large amount of ammonium salt was formed even at the temperature at which the hydrotreating was performed.

In Example 10, as the additional dehydration was performed using a coalescer, the content of moisture and chlorine after the dehydration were lower than those in other Examples, and therefore, the activation time of the catalyst, the process stability, and the quality of the refined pyrolysis oil were relatively superior to those in other Examples.

As set forth above, to various embodiments of the present disclosure, the method and system for producing refined hydrocarbons from waste plastics may produce a high-value-added pyrolysis oil having the above-noted high proportion of light hydrocarbons from waste plastics containing a large amount of impurities, and may obtain refined hydrocarbons having the above noted high proportion of light hydrocarbons and solid coke therefrom.

According to another embodiment of the present disclosure, refined hydrocarbons having a high proportion of light hydrocarbons and solid coke may be obtained from waste plastics, such that the cost efficiency of the process may be improved.

According to another embodiment of the present disclosure, the method and system for producing refined hydrocarbons from waste plastics may improve the yield of the pyrolysis oil obtained from waste plastics as compared to conventional processes used in the past.

According to another embodiment of the present disclosure, the method and system for producing refined hydrocarbons from waste plastics may produce a high-value-added pyrolysis oil with reduced impurities from waste plastics containing a large amount of impurities, and may obtain refined hydrocarbons with reduced impurities therefrom.

According to another embodiment of the present disclosure, the method and system for producing refined hydrocarbons from waste plastics may simplify the process when refined hydrocarbons are produced from waste plastics.

According to another embodiment of the present disclosure, the method and system for producing refined hydrocarbons from waste plastics may produce high-value-added pyrolysis oil having a high proportion of light hydrocarbons that may be used as a feedstock for blending with existing petroleum products or for an oil refining process due to its excellent quality, and may obtain refined hydrocarbons having a high proportion of light hydrocarbons and solid coke therefrom.

According to another embodiment of the present disclosure, the method and system for producing refined hydrocarbons from waste plastics may prevent or minimize formation of an ammonium salt (NH₄Cl) and may prevent the adhesion phenomenon of impurity particles when refining waste plastic pyrolysis oil containing impurities including chlorine and nitrogen.

According to another embodiment of the present disclosure, the method and system for producing refined hydrocarbons from waste plastics may prevent deactivation of the catalyst due to moisture, such that the refining efficiency may be excellent, and the process may be operated for a long period of time.

According to another embodiment of the present disclosure, the method and system for producing refined hydrocarbons from waste plastics may provide waste plastic pyrolysis oil that has significantly low contents of impurities such as chlorine, nitrogen, oxygen, and metals, and olefins, and has excellent quality, and thus, may be used as a feedstock for blending with existing petroleum products or for oil refining and petrochemical processes.

According to another embodiment of the present disclosure, the method and system for producing refined hydrocarbons from waste plastics may be used to produce eco-friendly petrochemical products using waste plastics as a feedstock.

The content described above is merely an example of applying the principles of the present disclosure, and other configurations may be used.

What is claimed is:

1. A method for producing refined hydrocarbons from waste plastics, the method comprising:
pretreating waste plastics;
producing a pyrolysis gas by introducing the waste plastics pretreated in the pretreatment process into a pyrolysis reactor;
producing in a lightening process a pyrolysis oil by introducing the pyrolysis gas into a hot filter;
dehydrating a first mixed solution, obtained by mixing the produced pyrolysis oil with washing water and a demulsifier, by applying a voltage to the first mixed solution;
hydrotreating a second mixed solution obtained by mixing the dehydrated first mixed solution with a sulfur source to produce a refined pyrolysis oil from which impurities are removed; and
coking the refined pyrolysis oil,
wherein a liquid condensed in the hot filter is re-introduced into the pyrolysis reactor.

2. The method of claim 1, wherein the hot filter is filled with beads.

3. The method of claim 2, wherein the beads include at least one selected from the group consisting of silica sand (SiO₂) and aluminum oxide (Al₂O₃).

4. The method of claim 1, wherein a temperature gradient is formed in the hot filter.

5. The method of claim 4, wherein the temperature gradient is formed by providing at least two heaters outside the hot filter.

6. The method of claim 1, wherein the pyrolysis reactor includes at least two batch reactors.

7. The method of claim 6, wherein the pyrolysis process is performed by switching operations between the at least two batch reactors.

8. The method of claim 1, wherein the refined pyrolysis oil is mixed with petroleum hydrocarbons and coked as mixed oil.

9. The method of claim 8, wherein the refined pyrolysis oil is included in an amount of 90 wt % or less with respect to the total weight of the mixed oil.

10. The method of claim 1, wherein the waste plastics include at least one selected from the group consisting of polyethylene (PE), polypropylene (PP), polyethylene terephthalate (PET), polyvinyl chloride (PVC), and polystyrene (PS).

11. The method of claim 1, wherein in the dehydration process, the pyrolysis oil is mixed in a greater volume than the washing water.

12. The method of claim 1, wherein in the dehydration process, the pyrolysis oil and the washing water are mixed in the first mixed solution at a volume ratio ranging from 1:0.001 to 0.5.

13. The method of claim 1, wherein in the dehydration process, the pyrolysis oil and the demulsifier are mixed in the first mixed solution at a volume ratio ranging from 1:0.000001 to 0.001.

14. The method of claim 1, wherein the demulsifier is one or a mixture of two or more selected from the group consisting of polyethylene glycol, tert-butanol, acetone, alkylnaphthalene sulfonate, alkylbenzene sulfonate, a nonionic alkoxylated alkyl phenol resin, polyalkylene oxide, and polyoxyethylene sorbitan ester.

15. The method of claim 1, further comprising, after the hydrotreating process, distilling the refined pyrolysis oil.

16. The method of claim 15, wherein hydrocarbons derived from the refined pyrolysis oil separated in the distilling and petroleum hydrocarbons are mixed and coked as mixed oil.

17. A system for producing refined hydrocarbons from waste plastics, the system comprising:
a pretreatment device for pretreating waste plastics;
a pyrolysis reactor for producing a pyrolysis gas by introducing the waste plastics pretreated in the pretreatment device;
a hot filter for producing a pyrolysis oil by introducing the pyrolysis gas;
a connection pipe connecting the hot filter and the pyrolysis reactor so that a liquid condensed in the hot filter is re-introducible into the pyrolysis reactor;
a dehydration device for dehydrating a first mixed solution, obtained by mixing the produced pyrolysis oil with washing water and a demulsifier, by applying a voltage to the first mixed solution;
a hydrotreating device for hydrotreating a second mixed solution obtained by mixing the dehydrated first mixed solution with a sulfur source to produce a refined pyrolysis oil from which impurities are removed; and
a coking device for coking the refined pyrolysis oil.

18. The system of claim 17, wherein the hot filter is filled with beads.

19. The system of claim 18, wherein the beads include at least one selected from the group consisting of silica sand (SiO₂) and aluminum oxide (Al₂O₃).

20. The system of claim 17, further comprising at least two heaters provided outside the hot filter.
